(19) United States
(12) Patent Application Publication
(10) Pub. No.: US 2014/0181547 A1
(43) Pub. Date: Jun. 26, 2014

(54) SMART CHARGING SYSTEM FOR HYBRID BATTERY PACK

(71) Applicant: NVIDIA CORPORATION, Santa Clara, CA (US)

(72) Inventor: Jevons Hua, Shenzhen (CN)

(73) Assignee: NVIDIA CORPORATION, Santa Clara, CA (US)

(21) Appl. No.: 13/727,445

(22) Filed: Dec. 26, 2012

(51) Int. Cl. G06F 1/26; G06F 1/32

(52) U.S. Cl. CPC G06F 1/263; G06F 1/3234
USPC 713/320; 713/300

(57) ABSTRACT

A hybrid battery pack and a power supply procedure for supplying power to a mobile computing system comprising a Li polymer battery coupled in parallel with a supercapacitor cell battery. The Li polymer battery supplies substantially all the continuous currents demanded by the system load. The supercapacitor cell battery supplies substantially all the transient current demanded by the system load. A charging control logic circuit is coupled to the power source and the system load, and operable to control the Li polymer battery to charge the supercapacitor cell battery at a constant rate while the supercapacitor cell battery supplies current to the system load. The control logic can also send instructions to have system load reduced if the supercapacitor cell battery is depleted before it can be charged with an external charger.

### TECHNICAL FIELD

The present disclosure relates generally to the field of computing systems and more specifically to the field of power supplies for computing systems.

### BACKGROUND

With the development of application programs, display qualities and storage capabilities of mobile devices, as well as the exponential growth of Internet information, the functions of mobile computing devices, including laptops, PDAs, media players, touchpads, smartphones, etc., have been increasingly expanded and refined. Accordingly, users have demanded longer continuous runtime of mobile devices. Thus, the operating lifetime of a battery has become one of the critical features of such products as it determines the utility of the mobile device in the normal situation where wall power is not easily accessible.

Mobile devices are commonly fitted with rechargeable Li-ion polymer batteries, or Li polymer batteries, which convert chemical energy to electrical energy through redox reactions. Li polymer batteries offer the advantages of high energy density, light weight, and high susceptibility to shaping, making them suitable for providing prolonged continuous usage time for mobile devices with slim designs.

However, Li polymer batteries usually have only moderate power density and cannot tolerate fast charge or discharge rates due to the nature of the chemical reactions in the cells. Typically, the maximum battery discharging rate is 1 C and a larger discharging rate may irreversibly reduce the battery capacity. For example, a discharging rate of 2 C may permanently damage the Li polymer battery. FIG. 1A is a data plot that illustrates the available capacity of a typical Lithium polymer battery used in a mobile device as a function of discharging rate. The curves 101-104 represent the battery Open Circuit Voltage (OCV) versus capacity at discharge rates of 0.2 C, 0.5 C, 1 C and 2 C respectively. It shows that the available capacity decreases with the increase of discharging rate. For example, at OCV of 3.5V, the available capacity at a discharge rate of 0.2 C is 3150 mAh; whereas the available capacity at a discharge rate of 2 C drops sharply to 600 mhA.

Furthermore, as a general rule, the amount of active chemicals transformed with each charge cycle is proportional to the depth of discharge. FIG. 1B is a data plot that illustrates the relation between the expected cycle life and the depth of discharge (DOD) for a typical rechargeable chemical battery, including a Li polymer battery. The number of cycles yielded by a battery, or the lifetime of the battery, goes down exponentially as the DOD goes deeper.

Transient currents are problematic to Li polymer batteries because they discharge the battery at high rates and likely cause deep discharge in a short time period. As a consequence, the operating lifetime of Li polymer batteries tends to deteriorate. In addition, Li polymer cells generally have relatively large internal impedance which renders slow responses to transient currents.

On the other hand, the mobile computing devices require more and more power for higher performance and working frequencies. High transient currents that exceed the maximum battery discharging limitation may frequently occur during the operations of the devices, for instance, when a hardware component is activated from a low power state to a high power state in a very short time interval. Therefore, a user typically experiences battery capacity declining over time and battery lifetime being shorter than claimed by the manufacturer.

### SUMMARY OF THE INVENTION

Therefore, it would be advantageous to provide a battery system to a mobile computing device with both large energy density and large power density, so that the battery system can reliably supply transient currents to the device without its operating lifetime and capacity being eroded over time by the transient currents.

Accordingly, embodiments of the present disclosure provide a mechanism to protect a Li polymer battery from the degrading effects caused by transient currents while at the same time providing a battery that can supply transient current according to a fast response time. Embodiments of the present disclosure advantageously employ a hybrid battery pack that includes a supercapacitor battery coupled in parallel with a Li polymer battery through a smart charging control logic circuit. The supercapacitor battery is operable to provide transient current and the Li polymer battery is operable to provide continuous current to an electronic system.

In one embodiment of the present disclosure, a method for providing power in a mobile computing system comprises: 1) supplying substantially all demanded current to the system from a primary battery while the demanded current is below a threshold rate; 2) supplying substantially all demanded current to the system from a secondary battery while the demanded current is equal to or greater than the threshold rate; and 3) supplying current to the secondary battery from the primary battery while said secondary battery supplying current to the system. The primary battery is coupled in parallel with said secondary battery. The control logic may enable only one battery at any time to supply current to the system. The primary battery may charge the secondary battery in a constant rate controlled by the control logic. Both batteries can be charged with an external charger. If the secondary battery is depleted before an external charger is connected, the control logic can instruct application processor frequencies to be throttled so as to reduce system load.

In another embodiment of the present disclosure, a method for providing power to a mobile computing system comprises: 1) supplying demanded current by the system from a primary battery while the demanded current is determined to be continuous; 2) supplying demanded current to the system from a secondary battery while the demanded current is determined to be transient; 3) charging the secondary battery by drawing current from the primary battery in a predetermined rate while the secondary battery supplying demanded current to the system; and 4) charging the two batteries responsive to detecting presence of an external charging device. They primary battery has higher energy density than said secondary energy density while the secondary battery is operable to withstand transient current reliably. If the secondary battery is depleted before an external charger is connected, the control logic can instruct application processor frequencies to be throttled so as to reduce system load.

In another embodiment of the present disclosure, a mobile computing system comprises a power source and a control logic circuit. The power source comprise a primary power component operable to supply continuous current and a secondary power component coupled in parallel to the primary power component and operable to supply transient current. The system load is coupled to the power source that demands current. The system load may comprise a display; a bus; a main processor; and a memory; and a control logic coupled to the power source. The control logic is operable to determine whether the current demanded by the system load is continuous or transient, disconnect the primary source component from the system load upon determining a transient current is demanded, and enable the primary power component upon determining a continuous current is demanded.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1A is a data plot illustrating the availably capacity as a function of discharging rate of a typical Lithium polymer battery used in a mobile computing device.

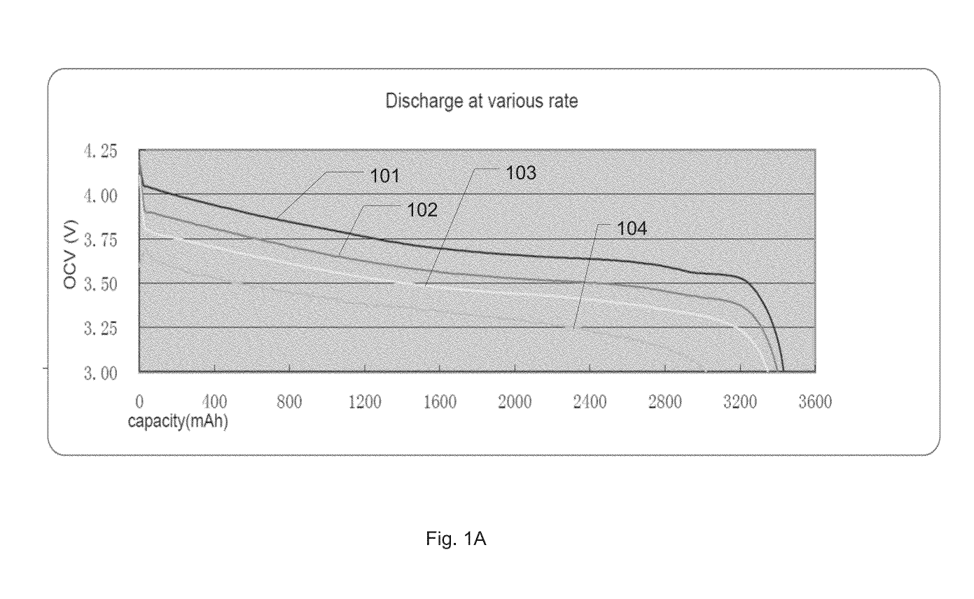

FIG. 1B is a data plot illustrating the relation between the expected cycle life and the depth of discharge for a typical rechargeable chemical battery.

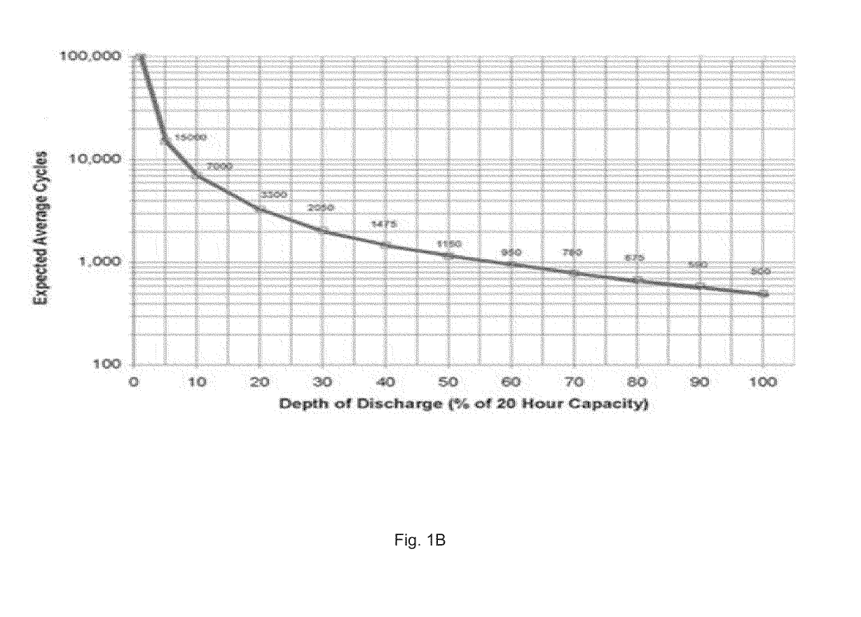

FIG. 2 is a block diagram illustrating a configuration of a hybrid battery pack coupled with a system load in accordance with an embodiment of the present disclosure.

FIG. 3 is a flow diagram of a method for providing power to a system load using a hybrid battery pack in accordance with an embodiment of the present disclosure.

FIG. 4 is a functional block diagram illustrating the configuration of a mobile computing system that comprises a hybrid battery pack coupled with other functional components in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Smart Charging System for Hybrid Battery Pack

Supercapacitor cells store energy through surface absorption of charges, as opposed to chemical reactions in the Li polymer batteries. Compared to Li polymer batteries, supercapacitor cell batteries are characterized having much higher power discharging capacities, or power densities, and smaller internal impedances. Thus, supercapacitor cell batteries are capable of supplying transient currents in a fast response time without negative effects on their operating lifetime or capacities. Although the feature of low energy density limits their application as the exclusive or primary battery in a mobile computing system, supercapacitor cells can be used as a secondary battery devoted to providing transient currents, in accordance with embodiments of the present disclosure.

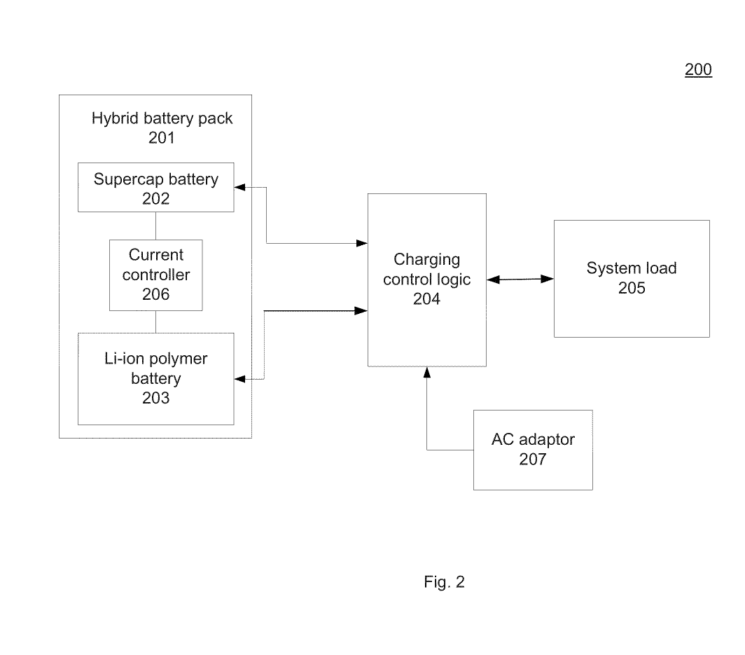

FIG. 2 is a block diagram illustrating a configuration 200 of a hybrid battery pack 201 coupled with a system load 205 in accordance with an embodiment of the present disclosure. The output current supplied from the hybrid batter pack 201 to the system load 205 is controlled by a charging control logic circuit 204. The hybrid battery pack 201 comprises a Li polymer battery 203 with a supercapacitor cell 202, each coupled to the system load 205. The Li polymer battery 203 has significantly higher energy density than the supercapacitor cell 202 and thus has the capacity to maintain constant voltage for long operating periods. In some embodiments, the Li polymer battery 203 is capable of storing 10˜100 times more energy than the supercapacitor cell 202. On the other hand, the supercapacitor cell 202 has significantly higher power density and can discharge at a significantly higher rate, e.g., 2 C or above, than the Li polymer battery 203, which accounts for its capability of tolerating transient current without sacrificing lifetime. In addition, the supercapacitor cell 202 has significantly lower internal impedance than the Li polymer battery 203. Accordingly to one embodiment, the internal impedances of Li polymer battery 203 and the supercapacitor cell battery 202 are approximately 180 mΩ and 15 mΩ respectively, for instance.

During normal operation, the system load 205 demands continuous current from the battery pack 201, which yield a discharging rate well within the nominal limit, e.g. 0.5 C, of the Li polymer battery 203. When the control logic 204 detects such current, the Li polymer battery 203 is enabled and supplies substantially all the demanded current to the system load 205. In this scenario, in some embodiments, the supercapacitor cell 202 may be electrically isolated from the system load 205. Moreover, when the system load 205 attempts to draw a transient current and so is detected by the control logic 204, e.g., at a rate larger than 0.5 C, the supercapacitor cell 202 advantageously is enabled and supplies substantially all the demanded current. In this event, the Li polymer battery 203 can be electrically isolated from the system load 205. In accordance with embodiments of the present disclosure, because the supercapacitor cell 202 has high power density and can operate reliably at high discharging rates, the transition offers the benefit of supplying the demanded current in a fast response time and protecting the Li polymer battery 203 from degrading effect caused by the high discharging rate. Thereby, the effective lifetime of the Li polymer battery 203 is advantageously extended.

In addition, the hybrid battery back is rechargeable by a compatible external charger, e.g. an AC adaptor 207. When the control logic 204 detects the connection to an AC adaptor 207, the AC adaptor 207 is used to supply all the current to the system load 205 and simultaneously charging batteries, 202 and 203. If the supercapacitor cell 202 is determined to be depleted before an AC adaptor 207 is connected, in accordance with embodiments of the present disclosure, the control logic can instruct the system to reduce system load by throttling application processor frequencies or lowering their operating voltages.

In some embodiments, the two batteries 202 and 203 are coupled in parallel so that they can charge each other. Although both batteries can be recharged to the same voltage level, a voltage difference on the two batteries may develop after a short operating time since the AC adaptor 207 is disconnected, which results in current flowing, or charging, between the two batteries due to their parallel connection. Due to the low energy stored in the supercapacitor cell 202, the supercapacitor cell likely loses voltage faster. Thus, there may be current flowing from the Li polymer battery 203 to the supercapacitor cell 202 attempting to equalize the voltages of the two, absent an active control over the current. Under some circumstances, this current may itself be a transient current and poses a risk of damaging the Li polymer battery 203. In some embodiments, to protect the Li polymer battery 203 from this risk, a current limiter 206 may be optionally connected between the two batteries to limit the current flowing between the two batteries.

In some embodiments, the control logic 204 can be used to actively control the charging between the two batteries, 202 and 203. In an exemplary embodiment, charging between the two batteries 202 and 203 is only permitted when the supercapacitor cell 202 is being used to supply current to the system load 205. In some embodiments, the charging current may be controlled at a constant rate, such as 0.5 C or lower.

In some embodiments the hybrid battery pack 201 may include more than one supercapacitor cell battery or Li polymer battery. According to one embodiment, the charging control logic 204 is disposed inside the hybrid battery pack 201.

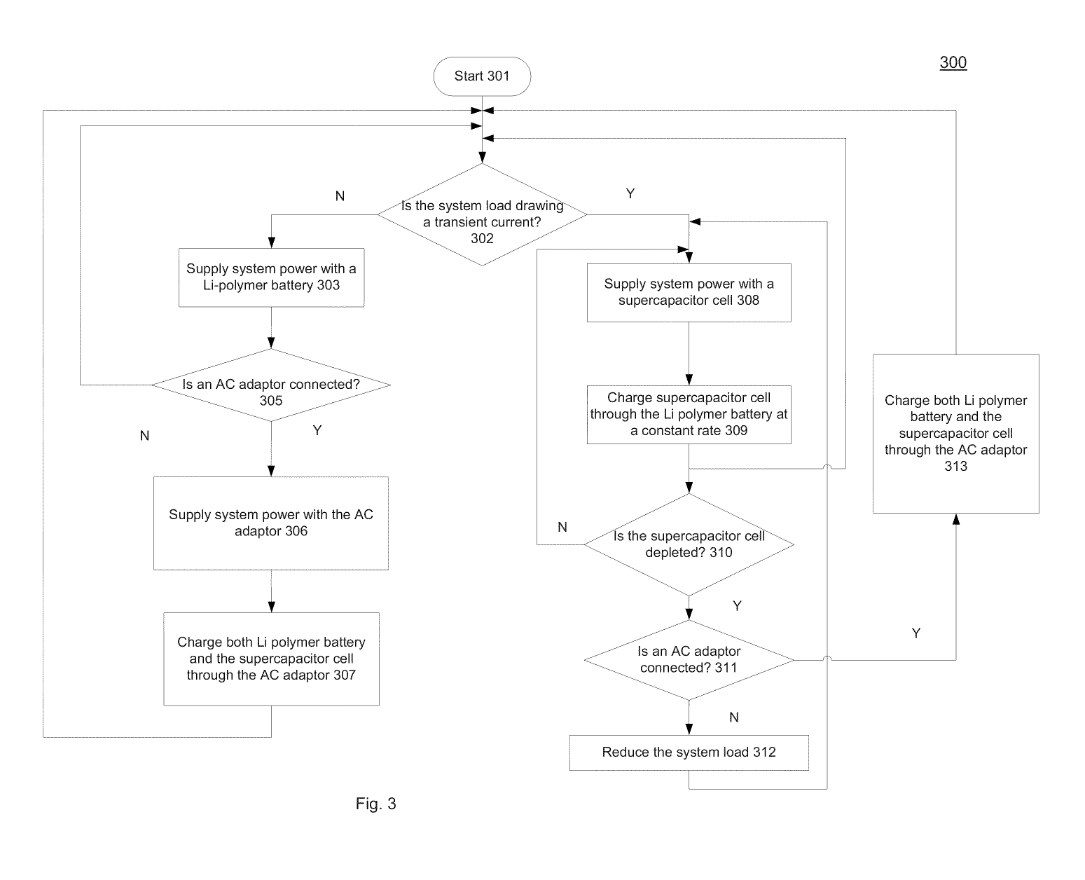

FIG. 3 is a flow diagram 300 depicting an exemplary process for providing power to a system load using a hybrid battery pack in accordance with an embodiment of the present disclosure. In the majority of the times, or the normal operation, the system load typically demands a continuous current that requires a discharge rate below a threshold rate from the battery pack. If the current is detected to be continuous at 302, the Li polymer battery supplies all the current to the system load at 303. The threshold rate can be any discharging rate at which the Li polymer battery is configured to operate without suffering degrading effect. According to one embodiment, the threshold rate is 0.5 C. Whenever an AC adaptor is connected to the mobile computing system at 305, the Li polymer battery and the supercapacitor cell are charged through the AC adaptor at 306. In some embodiments, once an AC adaptor is connected, the hybrid battery pack is isolated from the system load and the AC adaptor undertakes to supply substantially all the demanded power to the system load at 307.

On the other hand, if the current is determined to be above the threshold rate, or transient, at 304, the supercapacitor cell is advantageously used to supply substantially all current to the system load at 308. Meanwhile, the two batteries may charge each other at a constant rate at 309. If the supercapacitor cell is determined to be depleted at 310, and an AC adaptor is not detected at 311, the control logic may instruct the system to reduce the system load. In some embodiments, the system load can be reduced by throttling application processor frequencies and/or reducing the operating voltage. In case that an AC adaptor is detected at 311, both batteries are charged by the AC adaptor at 313.

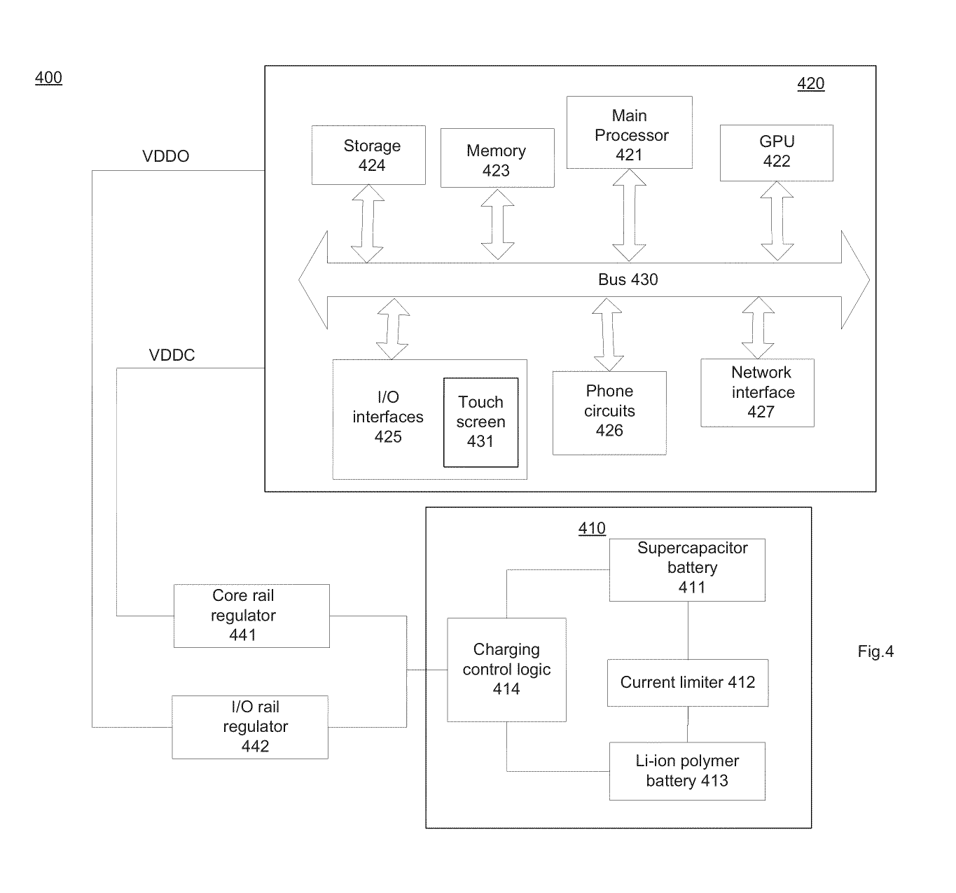

FIG. 4 is a functional block diagram 400 illustrating the configuration of a mobile computing system equipped with a hybrid battery pack 410 that is coupled with a system load 420 in accordance with an embodiment of the present disclosure. In some embodiments, the mobile computing device 400 can provide computing, communication and/or media play back capability. The mobile computing device 400 can also include other components (not explicitly shown) to provide various enhanced capabilities. The system load may 420 comprise a main processor 421 for processing electrical data, a memory 423, an optional Graphic Processing Unit (GPU) 422, network interface 427, a storage device 424, phone circuits 426, I/O interfaces 425 which may include a touch screen 431 and a bus 430, for instance.

The main processor 421 can be implemented as one or more integrated circuits and can control the operation of mobile computing device 400. In some embodiments, the main processor 421 can execute a variety of operating systems and software programs and can maintain multiple concurrently executing programs or processes. The storage device 424 can store user data and application programs to be executed by main processor 421, such as video game programs, personal information data, media play back program. The storage device 424 can be implemented using disk, flash memory, or any other non-volatile storage medium.

Network or communication interface 427 can provide voice and/or data communication capability for mobile computing devices. In some embodiments, network interface can include radio frequency (RF) transceiver components for accessing wireless voice and/or data networks or other mobile communication technologies, GPS receiver components, or combination thereof. In some embodiments, network interface 427 can provide wired network connectivity instead of or in addition to a wireless interface. Network interface 427 can be implemented using a combination of hardware, e.g. antennas, modulators/demodulators, encoders/decoders, and other analog/digital signal processing circuits, and software components.

I/O interfaces 425 provide communication and control between the mobile computing device 400 with other external I/O devices, e.g. a computer, an external speaker dock or media playback station, a digital camera, a separate display device, a card reader, a disc drive, in-car entertainment system, a storage device, user input devices or the like.

The hybrid battery pack 410, as described above, including a supercapacitor battery 411, a Li polymer battery 413, a current limiter 412, and a charging control logic 414 is coupled to and supplies demanded power to the system load 420 through voltage regulators 421 and 422.

The core rail regulator 421 regulates the power provided by the hybrid pack to a core domain voltage VDDC which is distributed to the core domain logic. The I/O rail regulator 422 regulates the power provided by the hybrid pack to an I/O domain voltage VDDO which is distributed to the I/O domain logic. In some embodiments, the system may comprise more than two power domains to which the hybrid battery pack 410 can supply power.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A method for providing power in a mobile computing system, said method comprising:
supplying substantially all demanded current to said mobile computing system from a primary battery while said demanded current is below a threshold rate;
supplying substantially all demanded current to said mobile computing system from a secondary battery while said demanded current is equal to or greater than said threshold rate; and
supplying current to said secondary battery from said primary battery while said secondary battery supplying substantially all demanded current to said mobile computing system; wherein said primary battery is coupled in parallel with said secondary battery.

2. The method as described in claim 1, wherein said supplying current to said secondary battery from said primary battery is controlled at a rate less than said threshold rate.

3. The method as described in claim 1 further comprising reducing current demanded by said mobile computing system responsive to said secondary battery being determined to be depleted while said mobile computing system draws current at a rate greater than said threshold rate.

4. The method as described in claim 3, wherein said reducing current comprises throttling application processor frequencies of said mobile computing system.

5. The method as described in claim 1, wherein said primary battery has higher energy density than said secondary energy density, wherein said secondary battery has higher discharging capacity than said primary battery, and wherein further said secondary battery has smaller internal impedance than said primary battery.

6. The method as described in claim 5, wherein said threshold rate is determined by a difference between an internal impedance of said primary battery and an internal impedance of said secondary battery.

7. The method as described in claim 1, wherein said threshold rate is predetermined to be 0.5 C.

8. The method as described in claim 1, wherein said primary battery comprises a Lithium polymer battery, and wherein said secondary battery comprises a supercapacitor battery.

9. The method as described in claim 1 further comprising:
detecting existence of an external power supply that is operable to charge said primary battery and said secondary battery, and operable to supply demanded current to said mobile computing system; and
charging said primary battery and said secondary battery with said external power supply.

10. A method as described in claim 9 further comprising
disabling said primary battery or said secondary battery from supplying current to said mobile computing system; and
supplying substantially all demanded current to said mobile computing system from said external power supply.

11. A method for providing power to a mobile computing system, said method comprising:
supplying demanded current by said mobile computing system from a primary battery while said demanded current is determined to be continuous;
supplying demanded current to said mobile computing system from a secondary battery while said demanded current is determined to be transient;
charging said secondary battery by drawing current from said primary battery in a predetermined rate while said secondary battery supplying demanded current to said mobile computing system; and
charging said primary and said secondary battery responsive to detecting presence of an external charging device, said external charging device operable to charge said primary battery and said secondary battery, and operable to supply demanded current to said mobile computing system; and wherein said primary battery has higher energy density than said secondary energy density, and wherein further said secondary battery is operable to withstand transient current reliably.

12. The method as described in claim 11, further comprising reducing a system load of said mobile computing system upon said secondary battery being determined to be depleted.

13. The method as described in claim 12, wherein said reducing the system load of said mobile computing system comprises throttling application processor frequencies of said mobile computing system.

14. The method as described in claim 11, wherein said primary battery comprises a Lithium polymer battery; and wherein said secondary battery comprises a supercapacitor cell.

15. The method as described in claim 11 further comprising deactivating said primary battery and said secondary battery upon detecting presence of an external charging device.

16. A mobile computing system comprising:
a power source comprising
a primary power component operable to supply continuous current;
a secondary power component coupled in parallel to said primary power component and operable to supply transient current;
a system load coupled to said power source that demands current from said power source, said system load comprising: a display; a bus; a main processor; and a memory; and
control logic coupled to said power source and operable to:
determine whether current demanded by said system load is continuous or transient;
disconnect said primary source component from said system load upon determining said current demanded to be transient; and
enable said primary power component upon determining said current demanded to be continuous.

17. The mobile computing system as described in claim 16, wherein said primary power component is operable to charge said secondary power component.

18. The mobile computing system as described in claim 17 further comprising a current regulator that is configured to control a charging current between said primary and said secondary power component.

19. The mobile computing system as described in 16 further comprising an AC adaptor operable to charge said primary and said secondary power component.

20. The mobile computing system as described in 16, wherein said primary battery comprises a Lithium polymer battery; and wherein said secondary battery comprises supercapacitor cell.
